(19) United States
(12) Patent Application Publication
(10) Pub. No.: US 2024/0336204 A1
(43) Pub. Date: Oct. 10, 2024

(54) STOWAGE APPARATUS FOR A MOTOR VEHICLE

(71) Applicant: Dr. Ing. h.c. F. Porsche Aktiengesellschaft, Stuttgart (DE)

(72) Inventors: Julia Stulle, Emden (DE); Bastian Freese, Stuttgart (DE)

(21) Appl. No.: 18/613,997

(22) Filed: Mar. 22, 2024

(30) Foreign Application Priority Data
Apr. 5, 2023 (DE) 10 2023 108 679.0

(51) Int. Cl. B60R 7/04

(52) U.S. Cl. CPC B60R 7/04

(57) ABSTRACT

A stowage apparatus (10) for a motor vehicle has a depositing compartment (14) for receiving objects, and a cover (16) that can be moved relative to the depositing compartment (14) for covering an opening (12) of the depositing compartment (16) in a closed position and for at least partially uncovering the opening (12) in an open position. An automatic substantially horizontal displacement of the depositing compartment (14) between a retracted position and an extended position is actuated by a movement of the cover (16) relative to the depositing compartment (14).

### CROSS-REFERENCE TO RELATED APPLICATION

This application claims priority on German Patent Application No 10 2023 108 679.0 filed Apr. 5, 2023, the entire disclosure of which is incorporated herein by reference.

### BACKGROUND

Field of the Invention. The invention relates to a stowage apparatus for a motor vehicle that enables objects to be stowed easily and safely.

Related Art EP 3 192 701 A1 discloses a stowage apparatus for a motor vehicle. The stowage apparatus has a recessed cup-holder that can be moved vertically upward when a lid covering the cup-holder is displaced into an open position.

The limited space in a motor vehicle creates a constant need for improvements in safe and easy stowage of objects. Accordingly, an object of the invention is to provide safe and easy space-saving stowing of objects in a motor vehicle.

### SUMMARY

One aspect of the invention relates to a stowage apparatus for a motor vehicle. The stowage apparatus has a depositing compartment for receiving objects and a cover that is displaceable between a closed position and an open position relative to the depositing compartment. The depositing compartment is closed when the cover is in the closed position and is open when the cover is in the open position. An automatic, substantially horizontal displacement of the depositing compartment between a retracted position and an extended position can be actuated by a relative movement of the cover towards the depositing compartment.

The cover that is in the closed position safely retains objects that had been deposited in the depositing compartment and prevents the objects from accidentally falling or flying out of the depositing compartment. The interior of the depositing compartment is accessible when the cover is moved to the open position so that objects can be deposited in or removed from the depositing compartment. The depositing compartment of some embodiments is displaceable horizontally, in particular in the X-direction. Thus, it is possible to move the depositing compartment into a receiving volume of a dashboard of the motor vehicle. More free space generally is available in a lower region of the dashboard than in the region of a central console of the motor vehicle. Accordingly, more stowage space for stowing objects can be obtained even in restricted space conditions.

The cover of some embodiments must be in the closed position to move the depositing compartment to the retracted position. Thus, the horizontal displacement of the depositing compartment into the dashboard will not be blocked by an object protruding from the depositing compartment, and no object can fall out of the depositing compartment and into an inaccessible location within the dashboard. Additionally, no object in the depositing compartment will impede movement of the depositing compartment out of the dashboard into the extended position.

The cover of some embodiments remains closed while moving the depositing compartment from the retracted position to the extended position. It is possible that the depositing compartment remains in the extended position for only a short time and then moves back to the retracted position. Accordingly, the volume occupied by the depositing compartment in the extended position is released and quickly becomes available again for other purposes. It is also possible that the depositing compartment intentionally remains in the extended position, e.g., to close another opening in the manner of a lid. This creates design freedoms and additional functionalities to increase the scope of functions in the interior of a motor vehicle and to create additional convenience.

Triggering the horizontal displacement of the depositing compartment between a retracted position and an extended position may occur automatically, e.g., by coupling the cover to the depositing compartment, so that a movement of the cover triggers a movement of the depositing compartment and/or so that a movement of the depositing compartment triggers a movement of the cover. As a result, a coupled kinematics system can be achieved between the depositing compartment and the cover, in which a user merely moves one of the parts, i.e., the cover or the depositing compartment, to achieve a collision-free movement of the other part, i.e. the depositing compartment or the cover. Thus, use is facilitated and the stowage apparatus will not be blocked. Automatic triggering of the horizontal displacement of the depositing compartment achieves easy, safe and space-saving stowing of objects in an interior of a motor vehicle.

An “X-direction” is understood to mean a coordinate direction along a longitudinal axis of a motor vehicle when the stowage apparatus is installed in the motor vehicle. The X-direction extends substantially horizontally when the motor vehicle is parked on a flat horizontal surface. A “Y-direction” is understood to mean a coordinate direction along a transverse axis of a motor vehicle when the stowage apparatus is installed in the motor vehicle. The Y-direction extends substantially horizontally when the motor vehicle is parked on a flat horizontal surface. A “Z-direction” is understood to mean a coordinate direction along a vertical axis of a motor vehicle when the stowage apparatus is installed in the motor vehicle. The Z-direction extends substantially vertically when the motor vehicle is parked on a flat horizontal surface. The X-direction, the Y-direction, and the Z-direction are oriented orthogonally to one another.

A mechanical, electrical or magnetic coupling may couple motion of the cover to the depositing compartment for displacing the depositing compartment and/or the cover. A mechanical coupling may use one or more pusher elements (e.g. on the cover) to engage one or more lever elements (e.g. on the depositing compartment, or on the dashboard or on the center console) so that a spring can move the depositing compartment from the retracted position to the extended position. An electronic coupling may use at least one drive motor (for example in the dashboard or in center console) that is actuated by a switch and a control device. The automatic triggering of horizontal displacement of the depositing compartment by the relative movement of the cover to the depositing compartment can be provided by mechanical and/or electrical motion coupling. For example, the cover initially can be displaced from the open position to the closed position via a dead section until a pusher can make contact against a stop of a lever, a steering lever or other component connected in articulated manner to displace the depositing compartment horizontally upon further movement of the cover to the closed position. The mechanical coupling can be comparable to a steering lever arrangement used in foldable convertible motor vehicle roofs. When moving to the closed position, the cover can actuate a scissor mechanism to move the depositing compartment into the extended position. An electric coupling may use limit sensors or reed switches to detect that the cover has reached a particular position relative to the depositing compartment. A drive motor for horizontally displacing the depositing compartment and/or for moving the cover can be disposed in the dashboard or the center console and can be started or stopped based on signals from the limit sensors or reed switches.

One aspect of this disclosure also relates to a stowage compartment for receiving a cellular telephone or other electronic device. The depositing compartment that is in the extended position at least partially covers a stowage compartment opening of the stowage compartment and/or in the opening position the cover at least partially covers the stowage compartment opening of the stowage compartment. The stowage compartment, which is different from the depositing compartment, can be provided at a height level provided below the depositing compartment. As a result, the depositing compartment that has been displaced horizontally into the extended position can form a lid for the stowage compartment. This enables two storage possibilities to be provided one above the other in the Z-direction in a space-saving manner. These two storage possibilities do not interfere with one another and do not impact against one another. In fact, in the extended position of the depositing compartment, it is possible to secure the objects stored in the stowage compartment and to create accessibility to the depositing compartment, and in an extended position of the depositing compartment, to secure the objects stored in the depositing compartment and to create an accessibility to the stowage compartment.

The cover that is in the open position at least partially, preferably fully, covers the opening of the stowage compartment. The cover that is in a central position at least partially, preferably fully, covers the opening of the depositing compartment and at least partially, preferably fully, uncovers the stowage compartment opening of the stowage compartment. The cover that is in the closed position, at least partially, preferably fully, covers the opening of the depositing compartment. Thus, in the central position, the cover blocks a displacement of the depositing compartment, and in the closed position, uncovers a cross section or surface facing in the X direction to enable displacement of the depositing compartment. In the central position of the cover, the cover can cover the depositing compartment not only from above but also on the side facing the interior of the motor vehicle (e.g. in the X direction), so that the depositing compartment and the objects received therein are secured. In the closed position, the depositing compartment can still be covered from above, although the horizontal movability of the depositing compartment is enabled, e.g., the cover no longer covers the side of the depositing compartment facing the interior of the motor vehicle (e.g. in the X direction). The depositing compartment can then move out under the cover in the closed position of the cover in the manner of a drawer and can uncover the opening of the depositing compartment in the extended position.

The stowage compartment of some embodiments has a charging structure for connecting and/or electrically charging devices, such as a cellular phone, arranged in the depositing compartment. With the aid of the charging structure, electronic devices can be supplied with electrical energy, e.g. to charge a cellular telephone. The device connected to the charging structure can provide an additional function for the driver and/or the passenger. Alternatively, the device placed in the stowage compartment and connected to the charging structure can be covered by the depositing compartment in the extended position, to prevent the driver from being distracted.

In some embodiments, a substantially vertical displacement of the stowage compartment between a recessed position and a raised position can be actuated automatically by a movement of the cover and/or the depositing compartment relative to the stowage compartment. This enables a device stored in the stowage compartment to be easily accessible and easily visible when the depositing compartment is in the retracted position. In addition, the device stored in the stowage compartment can protrude beyond an upper edge of the stowage compartment when the stowage compartment is in the raised position. When the stowage compartment is lowered into the recessed position, the otherwise protruding device can be lowered so far down that the depositing compartment can cover the stowage compartment and protect and/or conceal the device in the stowage compartment.

The cover of some embodiments is a roller blind that has lamellae that are connected movably one after the other, and are guided displaceably in at least one lateral guide rail. The roller blind can be, at least within certain limits, of changeable shape and can also follow a non-planar, curvilinear and/or wavy, movement path. It is thereby possible for the cover to perform a covering function at different height levels. For example, the cover can be moved from the closed position via a substantially S-shaped movement path from the height level of the opening of the depositing compartment to the height level of the stowage compartment opening of the stowage compartment. Thus, the cover, in the opening position, can cover the stowage compartment opening of the stowage compartment.

At least part of the depositing compartment may be contoured to form a cup holder. In the extended position of the depositing compartment, a user can safely deposit a beverage in the depositing compartment. In particular, if the depositing compartment in the extended position covers the stowage compartment, electronic devices stored in the stowage compartment can be protected from soiling or impairment by a spillage of the beverage. A detection device for detecting an object inserted into the cup holder may be provided so that a movement of the depositing compartment from the extended position to the retracted position can be prevented. In particular, the beverage inserted in the cup holder of the depositing compartment cannot be spilled accidentally if the depositing compartment is accidentally pushed towards the retracted position.

The invention also relates to a central console for arrangement between a driver seat and a passenger seat in an interior of a motor vehicle. The central console may have a stowage apparatus as described above. Thus, the depositing compartment can be retracted fully or partially into a dashboard in the retracted position and/or the cover is fully or partially retractable into the dashboard in the closed position. The central console may have the above-described a stowage compartment that cooperates with the stowage apparatus described above. An early, secure and space-saving stowing of objects in an interior of a motor vehicle is enabled by automatically triggering a horizontal displacement of the depositing compartment of the stowage apparatus.

The invention further relates to a motor vehicle interior having a central console as described above, and/or a stowage apparatus as described above and a dashboard adjoining the central console. The dashboard has a receiving volume for receiving the depositing compartment in the retracted position and/or for receiving the cover in the closed position. In the retracted position of the depositing compartment and in the closed position of the cover, the stowage apparatus can be received fully in the receiving volume of the dashboard. An easy, secure and space-saving stowing of objects in an interior of a motor vehicle is enabled by automatically triggering the horizontal displacement of the depositing compartment of the stowage apparatus.

The invention will now be described using preferred exemplary embodiments making reference to the accompanying drawings. The features described herein can represent an aspect of the invention both individually and in combination without limiting the scope of the invention.

### BRIEF DESCRIPTION OF THE DRAWINGS

FIG. 1 is a schematic perspective view of a stowage apparatus with a cover in an opened position relative to a depositing compartment.

FIG. 2 is a schematic perspective view of the stowage apparatus of FIG. 1 with the cover in a central position relative to the depositing compartment and with a stowage compartment uncovered.

FIG. 3 is a schematic perspective view of the stowage apparatus of FIG. 2 with the cover in a closed position relative to the depositing compartment and the stowage compartment uncovered.

FIG. 4 is a schematic perspective view of the stowage apparatus of FIG. 3 with a depositing compartment moving to the extended position and partly covering the stowage compartment.

FIG. 5 is a schematic side elevational view of the stowage apparatus illustrated in FIGS. 1-4.

### DETAILED DESCRIPTION

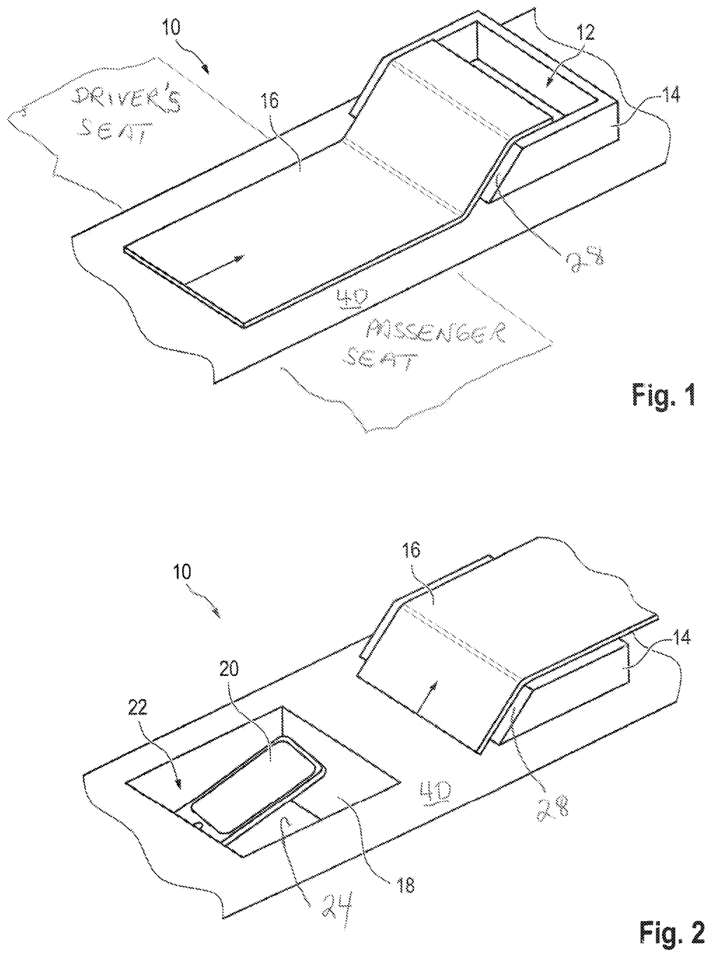

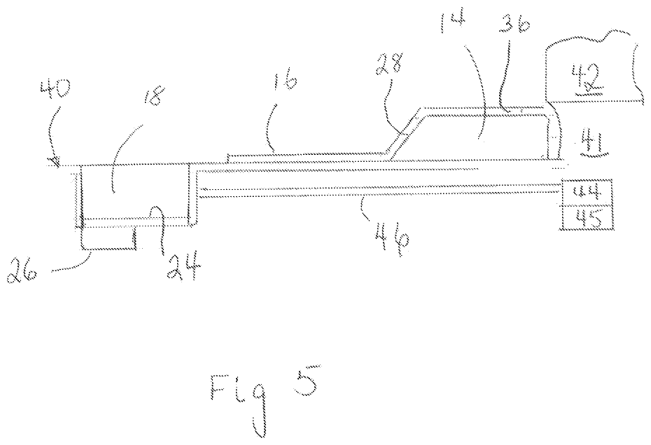

The stowage apparatus 10 shown in FIG. 1 can be used in an interior of a motor vehicle, in particular, in the region of a center console 40 and/or a dashboard 42, to stow objects in a depositing compartment 14 accessible via an upper opening 12. The opening 12 can be opened and closed by a cover 16, which in this embodiment is designed as a lamellar roller blind. In the opening position of the cover 16 shown in FIG. 1, the opening 12 of the depositing compartment 14, which can be situated completely in a receiving volume 41 of a dashboard 42, is at least partially opened. The cover 16 extends over a substantially S-shaped path 36, so that the cover 16 also covers a side 28 of the depositing compartment 14 facing towards the interior of the motor vehicle (e.g. in the X direction). A lower surface of the depositing compartment may be formed with at least one cup-holding recess 27, as shown in FIG. 4.

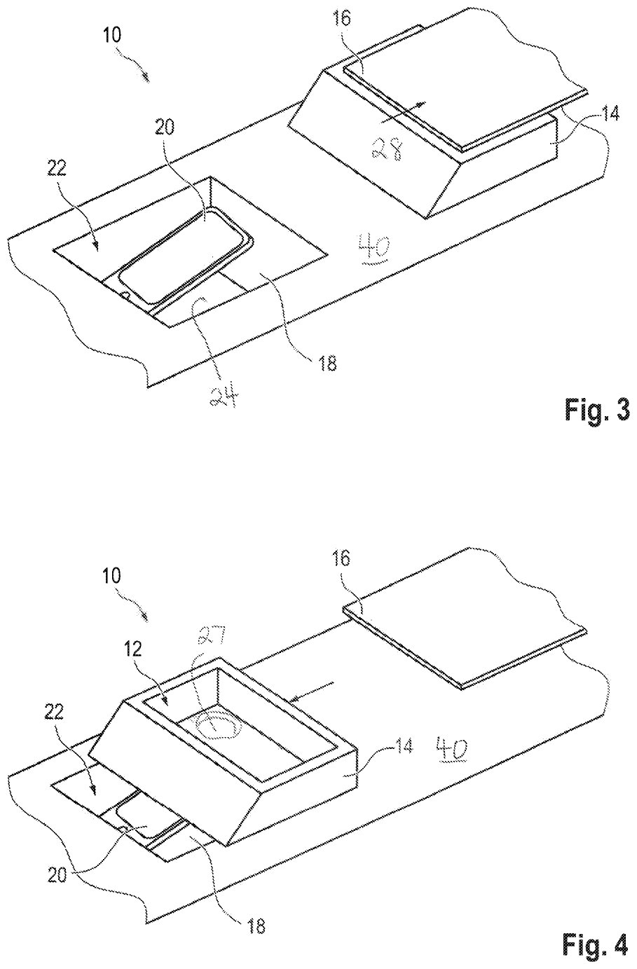

In a central position of the cover 16, as shown in FIG. 2, the opening 12 of the depositing compartment 14 is completely closed by the cover 16. However, a stowage compartment 18 that was covered and closed in the opening position of the cover 16 in FIG. 1 is uncovered in FIG. 2. Objects can be stored in the stowage compartment 18 via an upwardly facing depositing compartment opening 22. Preferably, electronic devices, such as a cellular telephone 20, can be stored on a floor 24 in the stowage compartment 18 and can be connected to a charging structure 26 for charging with electrical energy and/or to exchange data with a data infrastructure of the motor vehicle. The floor 24 of the stowage compartment 18 can be raised from the recessed position shown in FIGS. 2 and 3 to an elevated position where the floor 24 is substantially flush with the upper surface of the center console 40.

In the closed position of the cover 16 shown in FIG. 3, the opening 12 is still covered and closed, but the side 28 of the depositing compartment 14 facing the interior of the motor vehicle (e.g. in the X direction) is uncovered. The cover 16 can, e.g., be rolled up in a volume behind the depositing compartment 14 in a space-saving manner.

As shown in FIG. 4, the depositing compartment 14, which is horizontally displaceable in the X-direction, can be pulled out from its retracted position of FIG. 3 into the extended position of FIG. 4, in the manner of drawer. For example, the cover 16 has been moved so far into the closed position that a stop of the cover 16 is in contact with a switch element that has started a drive motor 44 pursuant to control provided by a control unit 45. The drive motor 44 can then automatically displace the depositing compartment 14 to the extended position after the cover 16 has reached the closed position. For example, a drive shaft 46 or other mechanical or magnetic connection between drive motor 44 the depositing compartment 14 and/or the cover 16 can be provided on or near an upper surface of the center console 40 or in guide path that projects from the upper surface of the center console 40 for guiding the movement of the cover 16. In the extended position, the depositing compartment 14 can cover the stowage compartment 18 and/or an object received in the stowage compartment 18, such as the cellular telephone 20. In this case, the opening 12 of the depositing compartment 14 previously covered by the cover 16 is simultaneously uncovered again and the depositing compartment is opened. This enables two storage options that do not interfere with each other to be provided on top of each other in a space-saving manner.

1. A stowage apparatus (10) for a motor vehicle, comprising:
a depositing compartment (14) having an opening (12) and being configured for receiving objects; and
a cover (16) displaceable relative to the depositing compartment (14) between a closed position for covering the opening (12) of the depositing compartment (16) and an open position for at least partially uncovering the opening (12), wherein
the cover (16) and the depositing compartment (14) are configured so that a movement of the cover (16) relative to the depositing compartment (14) triggers an automatic substantially horizontal displacement of the depositing compartment (14) between a retracted position and an extended position.

2. The stowage apparatus (10) of claim 1, further comprising a movement coupling device that couples the cover (16) to the depositing compartment (14), the movement coupling device generating the substantially horizontal displacement of the depositing compartment (14) between the retracted position and the extended position.

3. The stowage apparatus (10) of claim 2, wherein the movement coupling device comprises a mechanical coupling device with pusher elements and lever elements that engage for generating the substantially horizontal displacement of the depositing compartment (14) between the retracted position and the extended position.

4. The stowage apparatus (10) of claim 2, wherein the movement coupling device comprises an electronic coupling with at least one drive motor (44) actuated by a control device (45) for generating the substantially horizontal displacement of the depositing compartment (14) between the retracted position and the extended position.

5. The stowage apparatus (10) of claim 1, further comprising:
a stowage compartment (18) with a stowage compartment opening (22) configured to enable insertion of objects into the stowage compartment (18) and removing the objects from the stowage compartment (18);
the depositing compartment (14) at least partially covering the stowage compartment opening (22) of the stowage compartment (18) when the depositing compartment (14) is in the extended position; and
the cover (16) at least partially covering the stowage compartment opening (22) of the stowage compartment (18) when the cover (16) is in the closed position.

6. The stowage apparatus (10) of claim 5, wherein the cover (16) at least partially covers the stowage compartment opening (22) of the stowage compartment (18) when the cover (16) is in the open position.

7. The stowage apparatus (10) of claim 6, wherein the cover (16) is movable to a central position between the open position and the closed position, the cover (16) that is in the central position at least partially covers the opening (12) of the depositing compartment (14) and at least partially uncovers the stowage compartment opening (22) of the stowage compartment (18).

8. The stowage apparatus (10) of claim 7, wherein the cover (16) that is in the closed position at least partially covers the opening (12) of the depositing compartment (14).

9. The stowage apparatus (10) of claim 8, wherein the cover (16) that is in the central position blocks a displacement of the depositing compartment (14), and the cover (16) that is in the closed position, uncovers a cross section of the depositing compartment (14) for permitting displacement of the depositing compartment (14).

10. The stowage apparatus (10) of claim 5, wherein the stowage compartment (14) comprises a charging structure for connecting and/or electrically charging at least one electrical device arranged within the stowage compartment (18).

11. The stowage apparatus (10) of claim 5, wherein at least a floor of the stowage compartment (18) is substantially vertical displaceable between a recessed position and a raised position.

12. The stowage apparatus (10) of claim 11, wherein the stowage compartment (18) is substantially vertical displaceable between the recessed position and the raised position in response to movement of the cover (16) relative to the stowage compartment (18).

13. The stowage apparatus (10) of claim 11, wherein the stowage compartment (18) is substantially vertical displaceable between the recessed position and the raised position in response to movement of the depositing compartment (14) relative to the stowage compartment (18).

14. The stowage apparatus (10) of claim 1, wherein the cover (16) is a roller blind that comprises lamellae movably connected one after the other, wherein the lamellae are displaceably guided relative to the depositing compartment (14) depositing compartment (14).

15. The stowage apparatus (10) of claim 1, wherein the depositing compartment (14) comprises a cup holder (27).

16. A central console for arrangement between a driver seat and a passenger seat in an interior of a motor vehicle, the central console (40) comprising the stowage apparatus (10) of claim 1, wherein the depositing compartment (14) is recessed into a dashboard (42) in the retracted position and the cover (16) is at least partially retractable into the dashboard in the closed position.

17. An interior arrangement for an interior of a motor vehicle having a driver seat, a passenger seat, a central console (40) between the driver seat and the passenger seat, a dashboard (42) adjoining the central console (40), and the stowage apparatus of claim 1, the dashboard (42) having a receiving volume (41) for receiving the depositing compartment (14) in the retracted position and for receiving the cover (16) in the closed position.
